(19) United States
(12) Patent Application Publication
(10) Pub. No.: US 2018/0361750 A1
(43) Pub. Date: Dec. 20, 2018

(54) PRINT CARTRIDGE INSTALLATION REGION

(71) Applicant: Hewlett-Packard Development Company, L.P., Houston, TX (US)

(72) Inventors: Stephen G. BROEN, Vancouver, WA (US); Peter G. HWANG, Vancouver, WA (US); Dan R. DWYER, Battleground, WA (US); Shuiqiang LIN, Vancouver, WA (US); Aaron NELSON, Vancouver, WA (US)

(21) Appl. No.: 15/780,104

(22) PCT Filed: Mar. 31, 2016
(86) PCT No.: PCT/US2016/025405

§ 371 Date: May 30, 2018

(51) Int. Cl. B41J 2/175

(52) U.S. Cl. CPC B41J 2/17553; B41J 2/17543

(57) ABSTRACT

A print cartridge installation region includes a funneling wall formed on a substrate of the print cartridge installation region to guide a print cartridge into a predetermined position within the print cartridge installation region. The funneling wall includes a curved edge positioned at an opening of a print cartridge loading lane partially defined by the funneling wall.

### BACKGROUND

Printing devices are used to create physical representations of a document on a print media such as paper, plastics, cloth, or other mediums on which an image may be printed. The printing devices also consume a printing fluid such as ink in order to form the image on the print media. The printing fluid is loaded into print cartridges that are then inserted into an ink supply area of the printing device, and the printing device consumes the printing fluid by fluidically moving the printing fluid from the print cartridges within the ink supply area to other portions of the printing device where the image is printed on the print media.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a top view of a substrate of a print cartridge installation region, according to one example of the principles described herein.

FIG. 2 is an isometric view of a printing device including the substrate of the print cartridge installation region of FIG. 1, according to one example of the principles described herein.

FIG. 3 is an isometric view of the printing device of FIG. 2 within circle A, according to one example of the principles described herein.

FIG. 4 is another isometric view of the printing device of FIG. 2, according to one example of the principles described herein.

FIG. 5 is another isometric view of the printing device of FIG. 2, according to one example of the principles described herein.

FIG. 6 is a front view of the printing device of FIG. 2, according to one example of the principles described herein.

FIG. 7A is a bottom isometric view of a small form factor print cartridge utilized in the printing device of FIG. 2, according to one example of the principles described herein.

FIG. 7B is a front view of the small form factor print cartridge utilized in the printing device of FIG. 2, according to one example of the principles described herein.

FIG. 8A is a bottom isometric view of a large form factor print cartridge utilized in the printing device of FIG. 2, according to one example of the principles described herein.

FIG. 8B is a front view of a large form factor print cartridge utilized in the printing device of FIG. 2, according to one example of the principles described herein.

FIGS. 9A through 9D are top views of print cartridge loading lanes within a substrate of a print cartridge installation region, according to other examples of the principles described herein.

Throughout the drawings, identical reference numbers designate similar, but not necessarily identical, elements.

### DETAILED DESCRIPTION

As mentioned above, in some printing devices, a number of sizes and shapes of print cartridges may be loaded into the printing device for printing. Further, the method of loading ink supply print cartridges into a printing device may not be intuitive to a user. Thus, a user may become confused or frustrated during use of the printing device and during an ink supply replenishing process due to the lack of understanding as to how to load the ink supply print cartridges into the printing device. In some instances, this confusion and frustration may lead to an overall user-dissatisfaction with the printing device, and lead to a decrease in sales of the product. Further, this situation may lead to the user simply not using the printing device and allowing a number of resources to be wasted.

Examples described herein provide a print cartridge installation region. The print cartridge installation region includes a funneling wall formed on a substrate of the print cartridge installation region to guide a print cartridge into a predetermined position within the print cartridge installation region. The funneling wall includes a curved edge positioned at an opening of a print cartridge loading lane partially defined by the funneling wall. The print cartridge installation region includes a justification wall formed on the print cartridge installation region opposite the funneling wall. The justification wall and the funneling wall form the print cartridge loading lane into which the print cartridge is inserted. A number of indicators may be included on the surfaces of the print cartridge installation region to indicate a positioning of the print cartridge relative to the justification wall.

The print cartridge installation region includes a plurality of justification walls and funneling walls. The number of justification walls and funneling walls is equal to a number of colors utilized by a printing device in which the print cartridge installation region is installed.

The curved edge of the funneling wall curves in at least two coordinate directions. The funneling wall terminates along a distance of the funneling wall to a line parallel to the justification wall.

Examples described herein provide a print cartridge alignment system. The print cartridge alignment system includes at least one justification wall formed on a surface of a print cartridge bay, and at least one a funneling wall formed on the surface of the print cartridge bay opposite the justification wall to guide a print cartridge into a predetermined position within the print cartridge installation region. The funneling wall includes a curved edge positioned at an opening of a print cartridge loading lane partially defined by the funneling wall. The justification wall and the funneling wall form the print cartridge loading lane into which the print cartridge is inserted.

The print cartridge loading lane of the print cartridge alignment system includes dimensions to accept a number of volume sizes of print cartridges that each comprise a uniform mating surface with respect to the print cartridge loading lane.

In one example, an illumination is positioned next to the print cartridge bay. The illumination directs a user to the print cartridge bay.

The justification wall is differentiable relative to the remainder of the print cartridge bay. Further, the print cartridge alignment system includes a number of indicators to indicate a positioning of the print cartridge relative to the justification wall.

Examples described herein provide a printing device. The printing device includes, a print cartridge bay into which a number of print cartridges are installed, at least one justification wall formed on a surface of the print cartridge bay, and at least one funneling wall formed on the surface of the print cartridge bay opposite the justification wall to guide a print cartridge into a predetermined position within the print cartridge installation region. The funneling wall includes a curved edge positioned at an opening of a print cartridge loading lane defined by the funneling wall and the justification wall.

In one example, an illumination may be positioned next to the print cartridge bay. The illumination directs a user to the print cartridge bay. Further, an access door may be included in the printing device to enclose the print cartridge bay.

As used in the present specification and in the appended claims, the term “printable fluid” is meant to be understood broadly as any printing material that may be ejected or jetted from nozzles within a printing device. Jettable fluid may include, for example, inks, solutions, pharmaceuticals, and other jettable material.

As used in the present specification and in the appended claims, the term “print cartridge” is meant to be understood broadly as any container in which an amount of jettable fluid is contained. In one example, a print cartridge may be installed in a printing device, and an amount of the jettable fluid contained therein may be drawn by the printing device and used to form an image on a print medium such as paper. In on example, the print cartridge may include any number of amounts of jettable fluid, and different sizes or form factors of print cartridges may provide for different volumes contained therein.

Even still further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

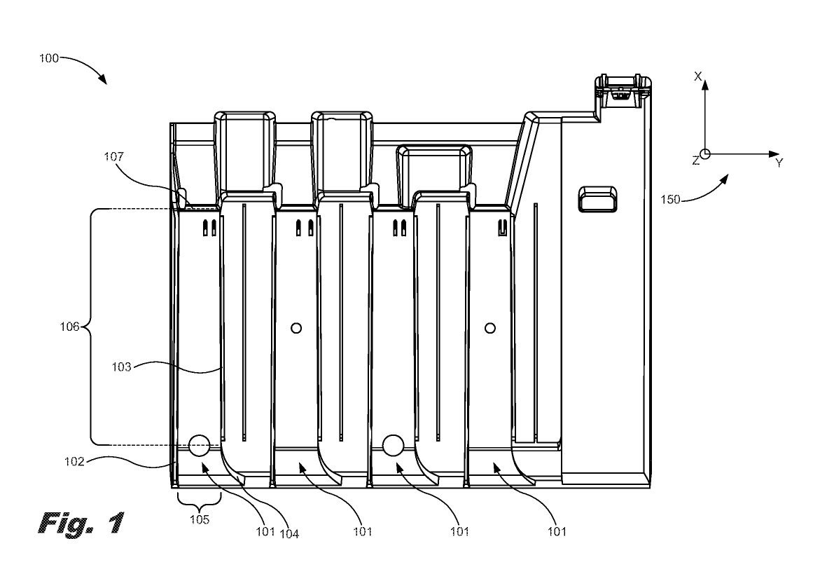

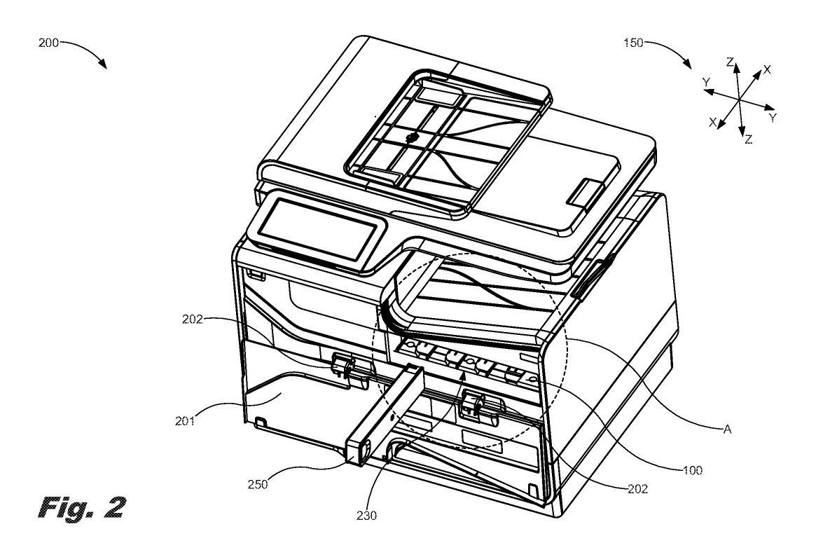

Turning now to the figures, FIG. 1 is a top view of a substrate (100) of the print cartridge installation region (230), according to one example of the principles described herein. Further, FIG. 2 is an isometric view of a printing device (200) including the substrate (100) of the print cartridge installation region (230) of FIG. 1, according to one example of the principles described herein. The substrate (100) of the print cartridge installation region (230) is included within a print cartridge installation region (230) of the printing device (200). The substrate (100) includes a number of features that assist in the installation of a number of print cartridges (250) into the printing device (200) in order to fluidically couple the print cartridges to the printing device (200). When the print cartridges (250) are installed in the printing device (200), the print cartridges (250) fluidically couple with the printing device (200), and the jettable fluid contained in the print cartridges (200) is made available to the printing device (200) for ejection during a printing process.

As depicted in FIG. 1, the substrate (100) of the print cartridge installation region (230) includes a number of elements that assist in aligning the print cartridges (250) within the printing device (200). The substrate (100) includes a number of print cartridge loading lanes (101) formed by a number of justification walls (102) and a number of funneling wall (103). The width (105) of the print cartridge loading lane (101) is defined by the distance between parallel portions of a justification wall (102) and a funneling wall (103).

Any number of justification wall (102) and funneling wall (103) pairs may be included within the substrate (100) of the print cartridge installation region (230). In one example, a plurality of justification wall (102) and funneling wall (103) pairs are included within the substrate (100) of the print cartridge installation region (230).

In another example, four justification wall (102) and funneling wall (103) pairs are included within the substrate (100) of the print cartridge installation region (230). In this example, a print cartridge loading lane (101) is formed for each of the four justification wall (102) and funneling wall (103) pairs. Print cartridges including cyan, magenta, yellow, and black colors of jettable fluid may each be installed in each of the four print cartridge loading lanes (101). In this example, the printing device (200) may be replenished with a color of jettable fluid. However, in other printing devices (200), print cartridges including different colors of jettable fluid other than cyan, magenta, yellow, and black may be installed based on the color model employed by the printing device (200). In this manner, the color model of the printing device (200) may influence the number of print cartridges and, consequently, the number of print cartridge loading lanes (101), justification walls (102), and funneling walls (103) included within the substrate (100) of the print cartridge installation region (230) of the printing device (200).

In the examples described herein, the justification wall (102) is located to the left of the funneling wall (103). In this example, the justification wall (102) is a left justification wall that provides for left justification of a print cartridge (250). However, in the examples described herein, the position of the justification wall (102) with respect to the funneling wall (103) may be either to the left or to the right of its respective funneling wall (103). A user, when installing a print cartridge (250) onto the substrate (100) within the printing device (200) may use the justification wall as a guide to insert the print cartridge (250) at a location and in an orientation with respect to the substrate (100) that provides for the print cartridge (250) to be fluidically coupled to the printing device.

In one example, the justification wall (102) may be differentiable relative to the remainder of the substrate (100) of the print cartridge installation region (230) and other neighboring portions of the print cartridge bay (230). For example, the justification wall (102) may be differentiable from other elements based on its color, texture, finish, material, size, or combinations thereof. For example, the justification wall (102) may protrude from surrounding surfaces of the substrate (100) to accent the existence of the justification wall (102). Further, the justification wall (102) may include a finish such as a glossy finish that differs from the finishes of the surrounding surfaces of the substrate (101) to accent the existence of the justification wall (102). In this manner, a user may easily identify the justification wall as a landmark or marker that may be used to more readily identify a correct positioning of the print cartridge (250) relative to the justification wall (102) and the remainder of the elements of the substrate (100) of the print cartridge installation region (230). Thus, causing the justification wall (102) to be more prominent in this manner reduces or eliminates a user's incorrect installation of the print cartridges (250).

The substrate (100) of the print cartridge installation region (230) also includes the funneling wall (103). The funneling wall (103) is formed opposite the justification wall (102), and the two walls (102, 103) form the print cartridge loading lane (101). Each funneling wall (103) included within the substrate (100) of the print cartridge installation region (230) includes a ramp (104) and a straight portion (106). In one example, the ramp (104) is formed on less than a total of the length of the funneling wall (103) with the straight portion (106) of the funneling wall (103) making up the remainder of the funneling wall (103). In this manner, a portion of the funneling wall (103) runs parallel to the justification wall (102) as is the case with the straight portion (106).

In one example, the ramp (104) may be curved with respect to at least two different coordinate directions. For example, as depicted in FIG. 1, the ramp (104) curves away from a straight line formed by the X-axis in the Y-direction as identified by the coordinate indicator (150). Further, the ramp (104) curves away from the Z-axis towards the X- and Y-axes such that the face of the ramp (104) as depicted in the top view of the substrate (100) of the print cartridge installation region (230) of FIG. 1 is viewable.

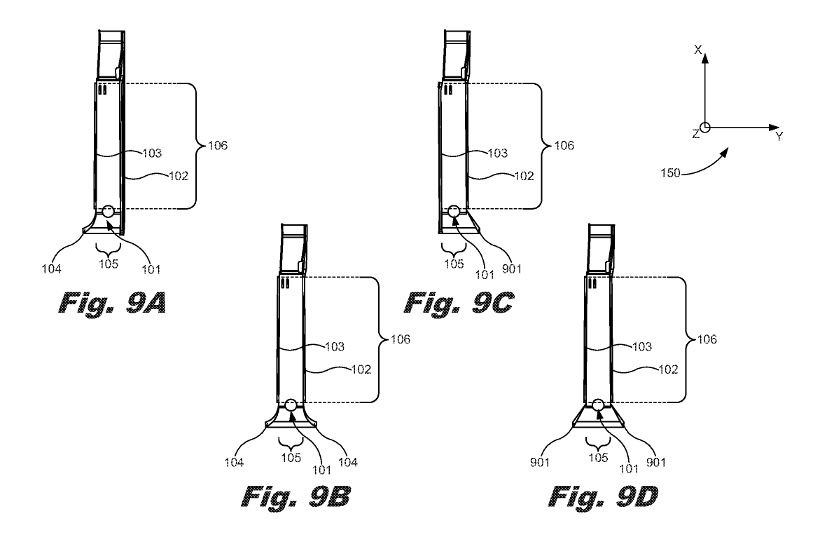

In another example, the ramp (104) may include a straight edge (FIGS. 9C and 9D, 901) angled with respect to the straight portion (106) of the funneling wall (103). In this example, the straight edge (901), like the ramp (104) in other examples described herein, serves to force the print cartridge (250) against the justification wall (102) as the print cartridge (250) is forced into the print cartridge installation region (230). More regarding these examples will be provided below.

The funneling wall (103) assists a user in correctly installing the print cartridges (250) by providing an initially wider orifice into which the print cartridge may be inserted and guiding the print cartridge into a position that abuts the justification wall (102). Thus, the tapering shape of the funneling wall (103) as the ramp (104) terminates at the beginning of the straight portion (106) forces the print cartridge (250) to abut the justification wall (102). When a user brings a print cartridge (250) into coupling position relative to the print cartridge loading lane (101), the user identifies the justification wall due to its prominence as described above. The user forces the print cartridge (250) in the X-direction. If the print cartridge (250) comes into contact with the surface of the ramp (104), the force applied by the user in the X-direction is translated into movement in the Y-direction towards the justification wall (102) such that the print cartridge (250) is forced to abut the justification wall (102). In this manner, the funneling wall (103) reduces or eliminates guess-work as to how the print cartridge (250) is inserted into the print cartridge loading lane (101) or how the print cartridge (250) fits between the justification wall (102) and the funneling wall (103). This increases ease of use for a user of the printing device (200) when the user replaces a spent print cartridge (250) for a new, full print cartridge (250) which, in turn, increases user satisfaction with the printing device as a product.

Thus, the justification wall (102) serves to guide the print cartridge (250), and the funneling wall (103) funnels or routes the print cartridge (250) into a correct position and against the justification wall (102) as the user applies force in the X-direction. In one example, the print cartridge (250) is secured in position once the print cartridge (250) is moved to a terminus (107) in the X-direction. In this example, the securing mechanism may include any number of latches, gates, fasteners, magnets, or other securing mechanisms. In another example, the top surfaces of the print cartridge installation region (230) may create an engineering fit such as a clearance fit, a transition fit, or an interference fit between itself, the print cartridge (250) and the substrate (100). In another example, the print cartridge (250) may be secured within the print cartridge installation region (230) using a combination of the above devices and techniques.

With reference again to FIG. 2, the printing device (200) includes an access door (201) that may be opened to access the print cartridge installation region (230). The access door (201) conceals the print cartridge installation region (230) and installed print cartridges (250) from view when closed, and keeps contaminants out of the print cartridge installation region (230). The access door (201) may be opened in order to install and replace the print cartridges (250), and include a number of hinges (202) that rotatably couple the access door (201) to the printing device (200).

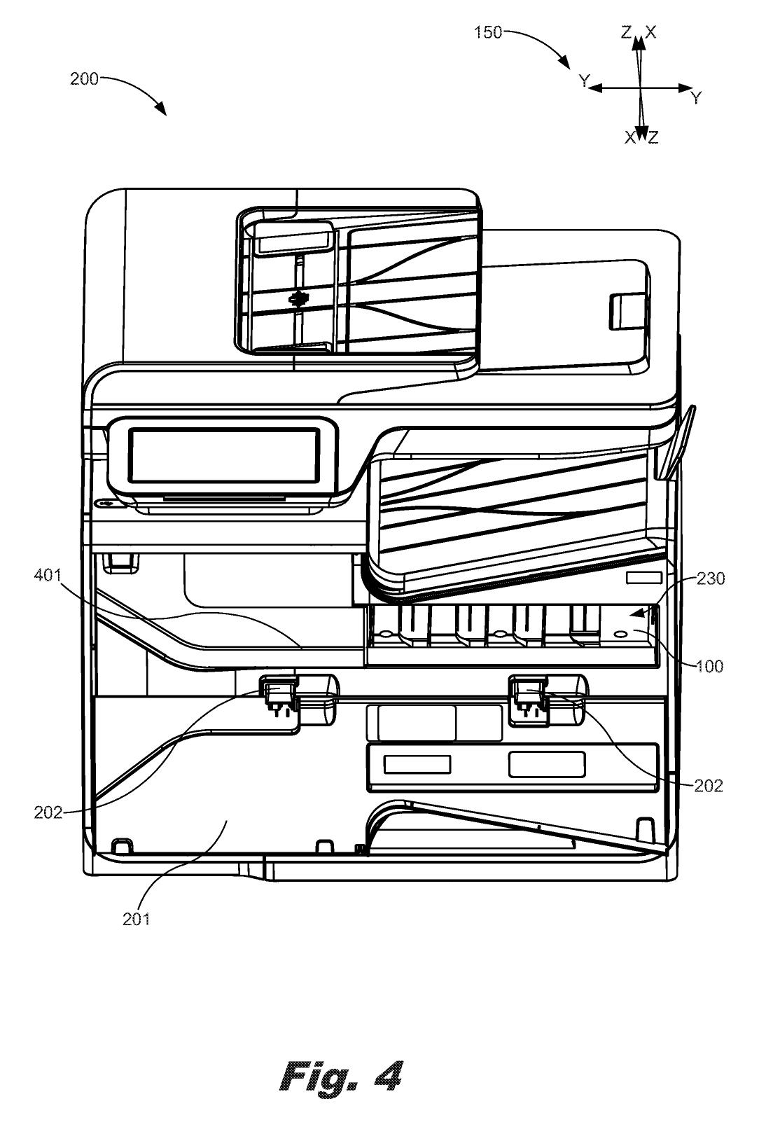

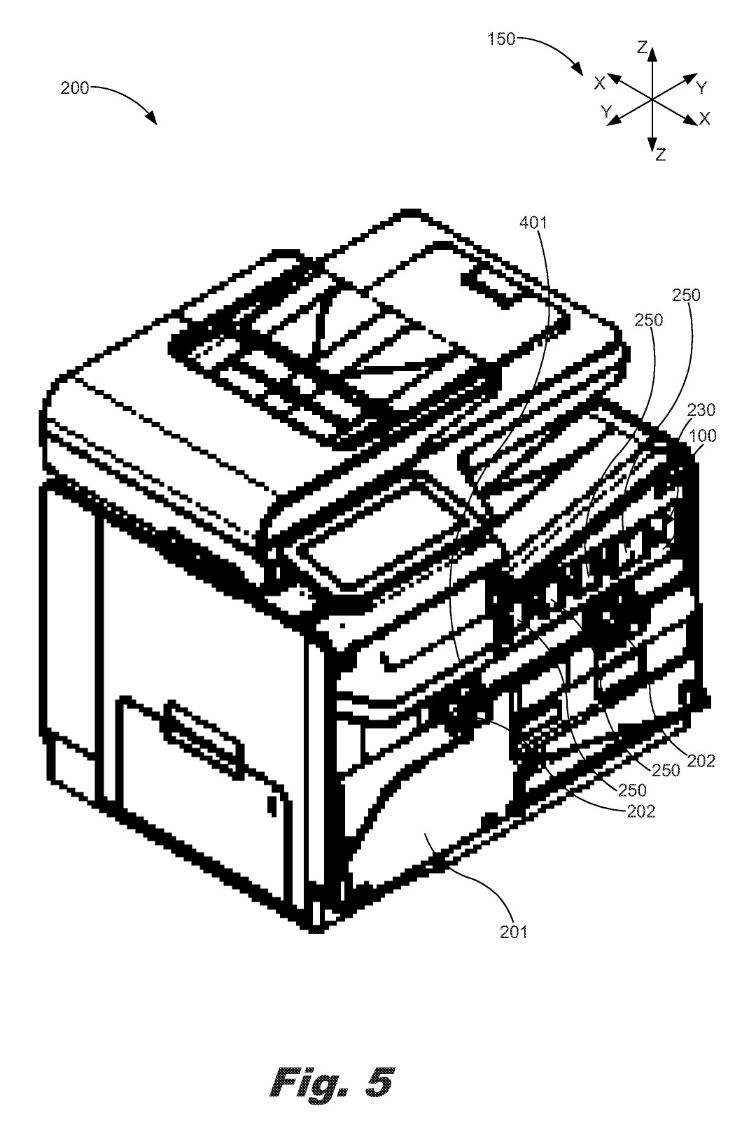

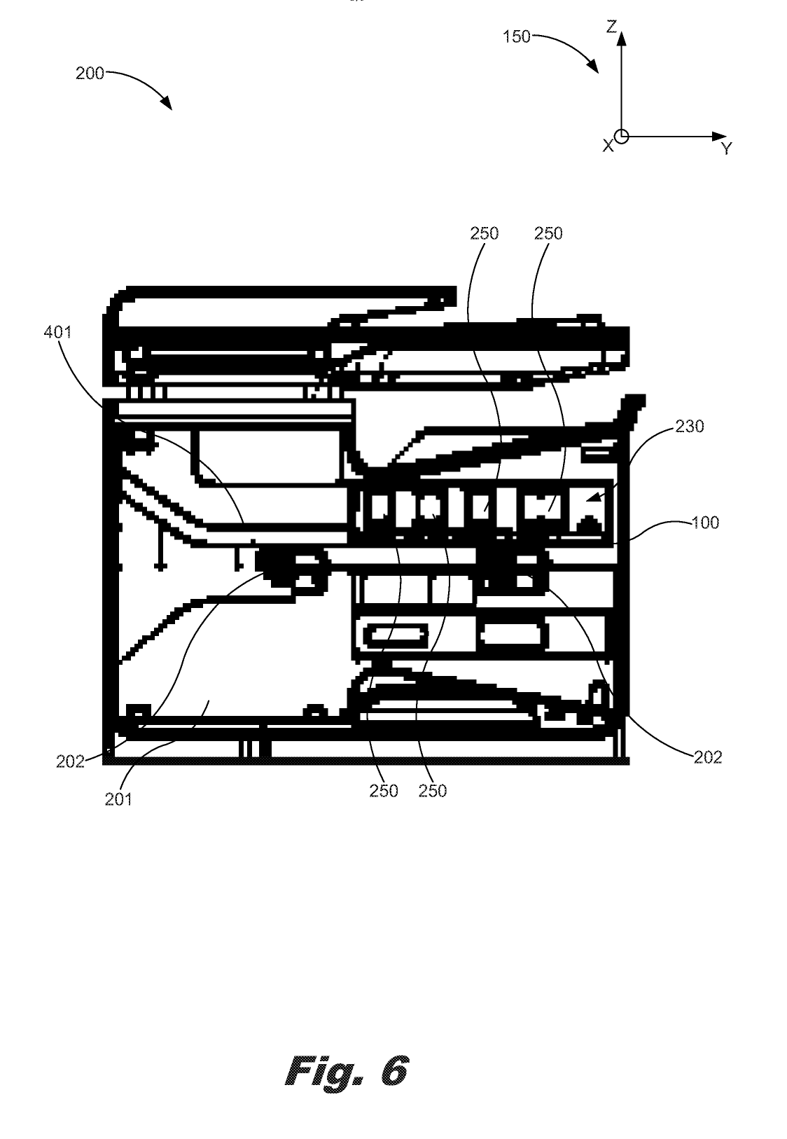

FIG. 4 is another isometric view of the printing device (200) of FIG. 2, according to one example of the principles described herein. Further, FIG. 5 is another isometric view of the printing device (200) of FIG. 2, according to one example of the principles described herein. Even further, FIG. 6 is a front view of the printing device (200) of FIG. 2, according to one example of the principles described herein. The additional views of FIGS. 4-6 provide another view of the print cartridge installation region (230), am access door (201) with its hinges (202), and in the case of FIGS. 5 and 6, a number of print cartridges (250) installed in the print cartridge bay (230). These additional figures are provided to depict these various elements in more detail.

Further, with reference to FIG. 4, the printing device (200) may include an attention line (401). The attention line (401) may be any graphic or device that draws a user's attention to the print cartridge installation region (230) and the print cartridges (250) contained therein. In one example, the attention line is formed from a different color, texture, finish, material, size, or combinations thereof with respect to the surrounding portions of the printing device (200) in order to separate the attention line from other features of the printing device (200). In another example, the attention line (401) may be illuminated using, for example, light emitting diodes (LEDs) or other illumination devices. In this example, the attention line (401) may include a number of illumination devices that sequentially illuminate along the length of the attention line (401) towards the print cartridge installation region (230) to cause a user's eyes to travel toward the print cartridge installation region (230).

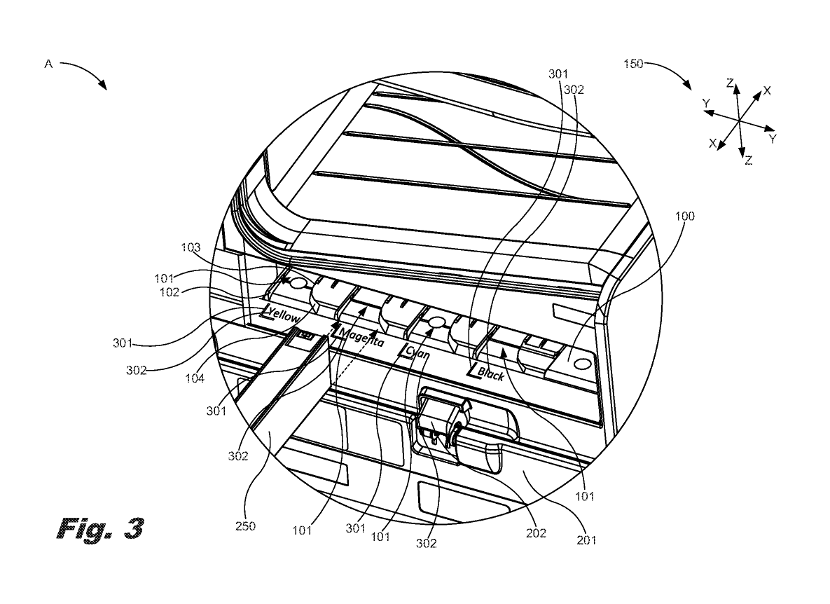

FIG. 3 is an isometric view of the printing device of FIG. 2 within circle A, according to one example of the principles described herein. The detail depicted in FIG. 3 includes a number of justification indicators (301) included on the substrate (100) of the print cartridge installation region (230). The justification indicators (301) may be differentiable from other elements based on its color, texture, finish, material, size, or combinations thereof in order to be viewable by a user. In the example of FIG. 3, the substrate (100) of the print cartridge installation region (230) includes four justification indicators (301); one for each color that may be utilized by the printing device (200). In this example, the four justification indicators (301) may be colored based on the color of jettable fluid contained in the print cartridge (250) that is to be inserted into that particular print cartridge loading lane (101) with which the justification indicators (301) are associated. Thus, in this example, the color of the left-most justification indicator (301) may be yellow in order to match the alphanumeric indicator (302) associated with the justification indicator (301) that reads “Yellow.” In one example, the justification indicators (301) may include an “L” shape that mimics the front-left edge of the print cartridge (250) as it is loaded into the print cartridge loading lane (101).

Thus, the justification indicator (301) serves to both indicate a justification of the print cartridge (250) as it is to be placed within the print cartridge loading lane (101), and also includes a color to indicate which color print cartridge (250) is to be installed in that print cartridge loading lane (101). The alphanumeric indicator (302) serves to assist a user in installing the correct color print cartridge (250) in the associated print cartridge loading lane (101). The justification indicator (301) and alphanumeric indicator (302) eliminate any guess work that may be involved in installing or replacing print cartridges (250) in the print cartridge installation region (230) of the printing device (200). This results in a user being more satisfied with the printing device (200) as a product since the printing device (200) is more user-friendly and easier serviceable.

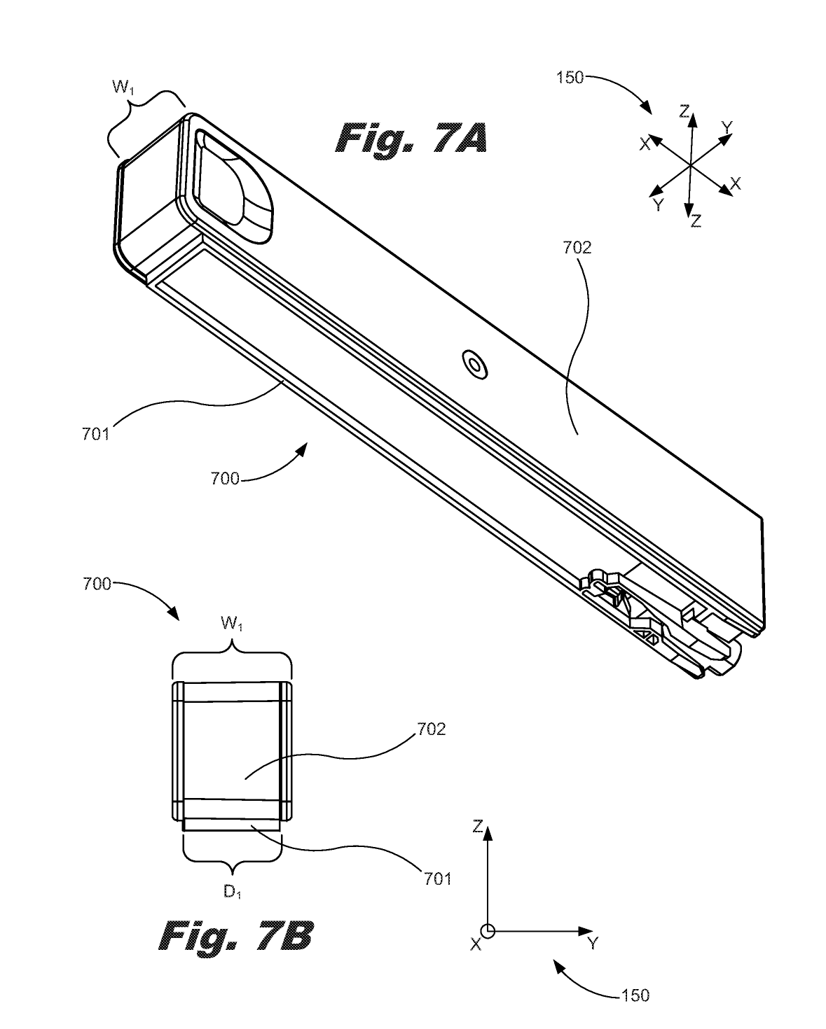

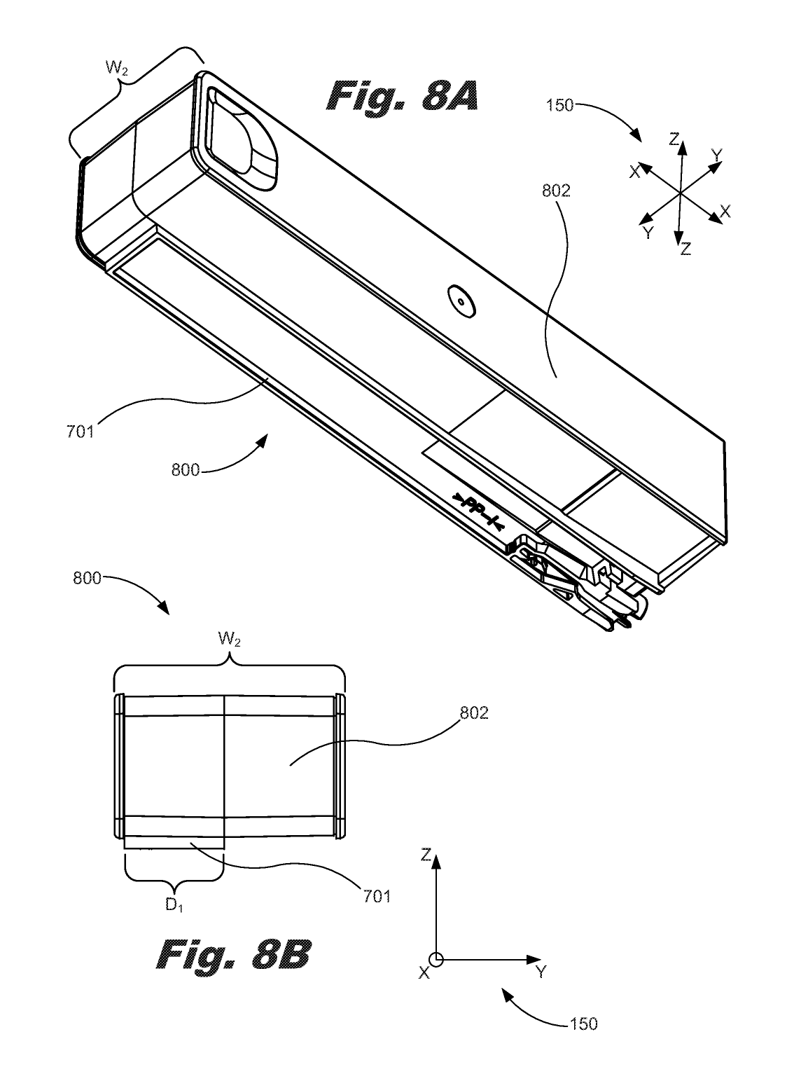

FIG. 7A is a bottom isometric view of a small form factor print cartridge (700) utilized in the printing device (200) of FIG. 2, according to one example of the principles described herein. 7B is a front view of the small form factor print cartridge (700) utilized in the printing device (200) of FIG. 2, according to one example of the principles described herein. FIG. 8A is a bottom isometric view of a large form factor print cartridge (800) utilized in the printing device (200) of FIG. 2, according to one example of the principles described herein. FIG. 8B is a front view of a large form factor print cartridge (800) utilized in the printing device of FIG. 2, according to one example of the principles described herein. The small form factor print cartridge (700) may have less jettable fluid contained therein relative to the large form factor print cartridge (800).

In one example, a top portion (702) of the small form factor print cartridge (700) may be approximately 25 millimeters (mm) in width (W₁), and a top portion (802) of the large form factor print cartridge (800) may be approximately 50 mm in width (W₂). However, as depicted in FIGS. 7 and 8, a base portion (701, 801) of the small form factor print cartridge (700) and large form factor print cartridge (800), respectively, may be of approximately the same dimension (D₁) as the print cartridge loading lanes (101) for the respective print cartridges (700, 800). Thus, as depicted in FIGS. 7 and 8, the bottom of the print cartridges (700, 800) includes the base portions (701, 801) that are raised or protruding from the print cartridges (700, 800). In the case of the small form factor print cartridge (700), the base portion (701) is approximately the same width as the print cartridge (700) or on the same order of size as the print cartridge (700). In contrast, the base portion (801) of the large form factor print cartridge (800) is approximately half the width of the print cartridge (800).

In other examples, the width (W1, W2) of the print cartridges (700, 800) may be wider or narrower than those depicted and described herein. However, the dimension of the base portions (701, 801) are the same in order to interface with the large form factor print cartridges (800). This allows for either a small form factor print cartridge (700) or a large form factor print cartridge (800) to be installed in a particular print cartridge loading lane (101). This flexibility in being able to install a print cartridge with a relatively larger volume of jettable fluid allows a user to install or replace the print cartridges (700, 800) less frequently. Further, having a universal base portion (701, 801) of the small form factor print cartridges (700) and large form factor print cartridges (800), respectively, removes user confusion as to how the print cartridges (700, 800) are installed since both the small form factor print cartridges (700) and large form factor print cartridges (800) are subjected to alignment within the print cartridge loading lane via the justification wall (102) and the funneling wall (103) as described herein.

The distance between print cartridge loading lanes (101) is large enough to accommodate for both the small form factor print cartridges (700) and large form factor print cartridges (800). When the large form factor print cartridges (800) are installed in the printing device (200), the top portions (801) do not obstruct the installation of neighboring print cartridges (800).

In one example, the different colors of print cartridges (250, 700, 800) may include different dimensions of their bases (701, 801) such that the bases (701, 801) act as a key. In this manner, a print cartridge (250, 700, 800) including a particular color of jettable fluid may not be inserted into a print cartridge loading lane (101) of a differently-colored print cartridge (250, 700, 800). In another example, the dimensions of the bases (701, 801) may be uniform, and a different keying system may be used to ensure that the correct color of print cartridge (250, 700, 800) is installed into a corresponding print cartridge loading lane (101).

FIGS. 9A through 9D are top views of print cartridge loading lanes (101) within a substrate (100) of a print cartridge installation region (230), according to other examples of the principles described herein. In the examples of FIGS. 9A through 9D, the print cartridge loading lanes (101) within a substrate (100) of a print cartridge installation region (230) may each include one justification wall (102) and one funneling wall (103), two justification walls (102), or two funneling walls (103). For example, FIG. 9A depicts a print cartridge loading lane (101) including a funneling wall (103) on the left-side and a justification wall (102) on the right side which is opposite of the orientation of these walls in, for example, FIG. 1.

FIG. 9B depicts a print cartridge loading lane (101) including a funneling wall (103) formed on both sides of the print cartridge loading lane (101). In this example, as the user inserts the print cartridge (250) into the print cartridge loading lane (101), both sides cause the print cartridge (250) be forced against each other and move toward the straight portions (106) of the funnels walls (103).

FIGS. 9C and 9D include a straight edge (FIGS. 9C and 9D, 901) angled with respect to the straight portion (106) of the funneling wall (103). In this example, the straight edge (FIGS. 9C and 9D, 901), like the ramp (104), assists in the shifting or moving of the print cartridges (250) towards the straight portions (106) of the funneling walls (103) and the justification walls (102).

Although the examples of FIGS. 9a through 9D include justification walls (102), at least one funneling wall (103) with a ramp (104), and at least one funneling wall (103) with a straight edge (FIGS. 9C and 9D, 901), any combination of these elements may be included within at least one print cartridge loading lanes (101). Further, in examples where more than one print cartridge loading lane (101) is included within the substrate (100), different print cartridge loading lanes (101) include differently shaped justification walls (102) and funneling walls (103), and different layouts and orientations as described in connection with FIGS. 9A through 9D.

In one example, the justification walls (102) and the funneling walls (103) on the substrate (100) may be relatively small compared to the dimensions of the print cartridges (250) and print cartridge loading lanes (101) themselves. This reduces wasted volume within the printing device (200), and reduces potential waste of manufacturing material during a manufacturing process of the substrate (100).

In one example, the printing device (200) may operate without a number of the print cartridges (250) installed, may operate by utilizing jettable fluid from less than all the cartridges (250), or combinations thereof. In this manner, the printing device (200) is able to print using one or more colors of jettable fluid, but less than all the cartridges (250) or colors of jettable fluid.

The specification and figures describe a print cartridge installation region includes a funneling wall formed on a substrate of the print cartridge installation region to guide a print cartridge into a predetermined position within the print cartridge installation region. The funneling wall includes a curved edge positioned at an opening of a print cartridge loading lane partially defined by the funneling wall. A justification wall may be formed on the print cartridge installation region opposite the funneling wall. The justification wall and the funneling wall form the print cartridge loading lane into which the print cartridge is inserted. This print cartridge installation region may provide for the correct installation of print cartridges within a printing device by assisting a user with a complete understanding as to how the print cartridges are to be installed within the printing device.

The preceding description has been presented to illustrate and describe examples of the principles described. This description is not intended to be exhaustive or to limit these principles to any precise form disclosed. Many modifications and variations are possible in light of the above teaching.

What is claimed is:

1. A print cartridge installation region, comprising:
a funneling wall formed on a substrate of the print cartridge installation region to guide a print cartridge into a predetermined position within the print cartridge installation region, the funneling wall comprising a curved edge positioned at an opening of a print cartridge loading lane partially defined by the funneling wall.

2. The print cartridge installation region of claim 1, comprising a justification wall formed on the print cartridge installation region opposite the funneling wall, the justification wall and the funneling wall forming the print cartridge loading lane into which the print cartridge is inserted.

3. The print cartridge installation region of claim 2, comprising a number of indicators to indicate a positioning of the print cartridge relative to the justification wall.

4. The print cartridge installation region of claim 2, wherein the print cartridge installation region comprises a plurality of justification walls and funneling walls.

5. The print cartridge installation region of claim 4, wherein the number of justification walls and funneling walls is equal to a number of print cartridges utilized by a printing device in which the print cartridge installation region is installed.

6. The print cartridge installation region of claim 1, wherein the curved edge of the funneling wall curves in at least two coordinate directions.

7. The print cartridge installation region of claim 2, wherein the funneling wall terminates along a distance of the funneling wall to a line parallel to the justification wall.

8. A cartridge alignment system comprising:
at least one justification wall formed on a surface of a cartridge bay; and
at least one a funneling wall formed on the surface of the cartridge bay opposite the justification wall to guide a cartridge into a predetermined position within the cartridge installation region, the funneling wall comprising a curved edge positioned at an opening of a cartridge loading lane partially defined by the funneling wall,
wherein the justification wall and the funneling wall form the cartridge loading lane into which the cartridge is inserted.

9. The cartridge alignment system of claim 8, wherein the cartridge loading lane comprises dimensions to accept a number of volume sizes of cartridges that each comprise a uniform mating surface with respect to the cartridge loading lane.

10. The cartridge alignment system of claim 8, comprising an illumination positioned next to the print cartridge bay, wherein the illumination directs a user to the cartridge bay.

11. The cartridge alignment system of claim 8, wherein the justification wall is differentiable relative to the remainder of the cartridge bay.

12. The cartridge alignment system of claim 8, comprising a number of indicators to indicate a positioning of the cartridge relative to the justification wall.

13. A printing device, comprising:
a print cartridge bay into which a number of print cartridges are installed;
at least one justification wall formed on a surface of the print cartridge bay; and
at least one funneling wall formed on the surface of the print cartridge bay opposite the justification wall to guide a print cartridge into a predetermined position within the print cartridge installation region, the funneling wall comprising:
a curved edge positioned at an opening of a print cartridge loading lane defined by the funneling wall and the justification wall.

14. The printing device of claim 13, comprising an illumination positioned next to the print cartridge bay, wherein the illumination directs a user to the print cartridge bay.

15. The printing device of claim 13, comprising an access door to enclose the print cartridge bay.
